(19) United States
(12) Patent Application Publication
(10) Pub. No.: US 2025/0125604 A1
(43) Pub. Date: Apr. 17, 2025

(54) PRECAST CONCRETE UTILITY VAULT

(71) Applicants: Arthur Mulqueen, Seaford, NY (US); Leonard Burshtein, Plainview, NY (US)

(72) Inventors: Arthur Mulqueen, Seaford, NY (US); Leonard Burshtein, Plainview, NY (US)

(21) Appl. No.: 18/491,400

(22) Filed: Oct. 20, 2023

Related U.S. Application Data
(60) Provisional application No. 63/590,298, filed on Oct. 13, 2023.

(51) Int. Cl. H02G 9/10

(52) U.S. Cl. CPC H02G 9/10

(57) ABSTRACT

A precast concrete utility vault with an upper riser section and a lower riser section. The upper riser section may have an open top, while the lower riser section may have a slab, or floor, section, which may include a sump channel. The upper and lower riser sections are formed in a controlled environment, such as a plant or factory, and transported to the work site, where the lower riser section is installed first and the upper riser section is then placed on the lower riser section. The upper and lower riser sections are then secured through construction joints.

### CROSS-REFERENCE TO RELATED APPLICATIONS

The present application claims priority to previously filed provisional patent application No. 63/590,298, filed on Oct. 13, 2023.

### FIELD OF INVENTION

The present disclosure relates to precast concrete vaults, typically though not necessarily located underground, that are used to house components of utilities, including transformers.

In the present context, “underground” can mean either completely under the surface of the surrounding terrain or, more commonly, under the surface but with a top, or roof, that is level with the surrounding terrain, and that usually has a portion, such as a grate, in air communication with the surrounding terrain. The surrounding terrain may be ground or a constructed surface, such as asphalt (e.g., a street or sidewalk).

### BRIEF DESCRIPTION OF THE DRAWINGS

FIG. 1 shows a top view of the present utility vault with a roof slab in place.

FIG. 2 shows a top view of the present utility vault without a roof slab in place.

FIGS. 3A and 3B show the present two-piece utility vault from, respectively, perspectives A-A and C-C of FIG. 2, while FIG. 3C shows a detail of the conduit openings shown in perspective C-C.

FIG. 4A shows the present utility vault from perspective B-B of FIG. 2, while FIG. 4B is an enlargement of detail A.

FIGS. 5A-5C show the upper riser section and lower riser section of the present utility vault from, respectively, perspectives A-A, B-B, and C-C of FIG. 2, with perspective B-B of FIG. 5B also showing the sump bottom.

FIGS. 6A-67C show three embodiments of construction joints to secure the upper riser section and lower riser section of the present utility vault to each other.

FIG. 7 shows an alternative top view of the present utility vault without a roof slab in place.

FIGS. 8A and 8B show an alternative view of the present utility vault from, respectively, perspectives A-A and C-C of FIG. 7, and FIG. 8C shows a detail of the conduit openings shown in perspective C-C.

FIG. 9A shows an alternative view of the present utility vault from perspective B-B of FIG. 8, with detail A shown in FIG. 9B.

FIGS. 10A-10B show two embodiments of construction joints to secure the upper riser section and lower riser section of the present utility vault to each other.

FIG. 11 shows another alternative top view of the present utility vault without a roof slab in place.

FIG. 12A shows yet another alternative view of the present utility vault from perspective B-B of FIG. 11, and FIG. 12B is an enlarged view of detail A.

FIG. 13 shows a yet further alternative top view of the present utility vault without a roof slab in place.

FIGS. 14A and 14B show an alternative view of the present utility vault from, respectively, perspectives A-A and C-C of FIG. 13, while and FIG. 14C shows a detail of the conduit openings shown in perspective C-C.

### SUMMARY

In one embodiment the present disclosure is directed to a precast concrete utility vault having a rectangular upper riser section of 5,000 psi precast concrete formed as a single piece with four upper riser walls and having an open bottom. Each upper riser wall has a top section with a top surface, and a bottom section with a bottom surface. The upper riser section may have a weight of between about 30,000 and 45,000 pounds, or between about 40,000 and about 45,000 pounds; an upper riser wall thickness of between about 8 inches and 12 inches, a length of between about 10 feet and 14 feet, a width of between about 10 feet and 12 feet, and a height of between about 7 feet and 9 feet. The present precast concrete utility vault may further include a rectangular lower riser section of precast concrete formed as a single piece with four lower riser walls having an open top, and joined at bottom by a slab section having an upper surface. Each lower riser wall has an upper section and a top surface. The lower riser section may have a weight of between about 50,000 and 65,000 pounds, or between about 60,000 and about 65,000 pounds; a lower riser wall thickness of between about 8 inches and 12 inches, a length of between about 10 feet and 14 feet, a width of between about 10 feet and 12 feet, and a height of between about 5 feet and 7 feet.

The bottom section of the upper riser walls may include an inner portion and an outer portion, with the outer portion extending between about 4 inches and about 8 inches below the inner portion and having a thickness of between about 4.5 inches and 5.5 inches. The upper section of the lower riser walls includes an outer portion and an inner portion, with the inner portion extending between about 4 inches and about 8 inches above the outer portion and having a thickness of between about 4.5 inches and 5.5 inches. The inner and outer portions of the upper riser wall, and the outer and inner portions of the lower riser wall, are aligned and configured so that, when the upper riser section is aligned with and placed on the lower riser section, the outer portion of the upper riser wall engages the outer portion of the lower riser wall, and the inner portion of the upper riser wall engages the inner portion of the lower riser wall, thereby securing the upper riser section and the lower riser section together.

The slab section may include a sump channel along substantially the entire length of one of the lower riser walls. The sump channel may have a depth of between about 1.5 feet and about 2.5 feet below the upper surface of the slab section, and a width of between about 2 feet and about 3 feet, and a length of between about 8 feet 8 inches and 9 feet 8 inches.

Each of the bottom sections of the upper riser walls includes a first portion and a second portion, with the second portion extending between about 3.5 inches and about 4.5 inches below the first portion and having a thickness of between about 4.5 inches and 5.5 inches. The second portion includes a plurality of metal plates partially embedded therein coplanar with the upper riser wall. The metal plates, which may be steel plates, may have a thickness of between about 0.4 inches and 0.6 inches, a length of between about 11 inches and about 13 inches, and a height of between about 11 inches and about 13 inches. Each of the metal plates includes a portion that extends below the bottom surface of the upper riser wall by between about 5 inches and about 7 inches.

In addition, each of the upper sections of the lower riser walls includes a first portion and a second portion, with the first portion extending between about 3.5 inches and about 4.5 inches above the second portion and having a thickness of between about 4.5 inches and about 5.5 inches. The second portion also includes a plurality of slots formed therein, with each slot having a length, width, and depth that corresponds to the length, width, and depth of the portion of the metal plates extending below the bottom surface of the upper riser wall.

The metal plates and the slots are arranged and configured so that, when the upper riser section is aligned with and placed on the lower riser section, each of the plurality of metal plates engages with each of the plurality of slots to secure the upper riser section and the lower riser section to each other.

In an alternative embodiment, each of the bottom sections of the upper riser walls may have an inner portion, a middle portion, and an outer portion. The middle portion extends between about 3.5 inches and about 4.5 inches beyond each of the inner portion and the outer portion, and has a thickness of between about 3 inches and about 4 inches. The upper riser walls have embedded therein a plurality of reinforcing bars, such as those commonly referred to as rebar, that are oriented vertically with respect to the upper riser walls, are positioned midway between the inner portion and the outer portion, and extend into the middle portion. Each of the plurality of reinforcing bars may have a diameter of about 0.5 inches. In this embodiment, each of the upper sections of the lower riser walls may have an inner portion, a middle portion, and an outer portion, with the middle portion being recessed between about 3.5 inches and about 4.5 inches below each of the inner portion and the outer portion, and having a width of between about 3 inches and about 4 inches. The middle portion of the upper riser walls and the middle portion of the lower riser walls are arranged and configured so that, when the upper riser section is aligned with and placed on the lower riser section, the middle portion of the upper riser walls fits within the middle portion of the lower riser walls to secure the upper riser section and the lower riser section to each other.

In yet another embodiment of the present precast utility vault, each of the bottom sections of the upper riser walls may have an inner portion, a middle portion, and an outer portion, with the middle portion extending between about 3.5 inches and about 4.5 inches beyond each of the inner portion and the outer portion, and having a thickness of between about 3 inches and about 4 inches. The top surface of the top section of the upper riser walls may have a plurality of recesses that are positioned centrally in the upper riser walls and have a width of about 4 inches, a length of about 4 inches, and a depth of about 4 inches. Each of the plurality of recesses has a bottom surface that includes a cylindrical aperture positioned centrally in the bottom surface. The cylindrical aperture has a diameter of between about 0.75 inches and about 1.5 inches, and extends vertically downward through the upper riser wall and terminates in an aperture in the bottom surface of the bottom section of the upper riser wall. Each of these cylindrical apertures contains a rigid plastic sleeve having an outer diameter equal to the diameter of the cylindrical apertures, and an inner diameter. (For purposes of the present disclosure, describing the rigid plastic sleeve as having an outer diameter “equal to” the diameter of the cylindrical apertures means that the outer diameter of the rigid plastic sleeves and the inner diameter of the cylindrical apertures is such that the rigid plastic sleeves fit within the cylindrical apertures.)

Each of the rigid plastic sleeves contains a first coil rod that extends throughout the cylindrical aperture and has a top and a bottom. The coil rod bottom has an externally threaded portion that extends beyond the middle portion of the bottom sections of the upper riser walls, and the coil rod top has a coil nut that is accessible through the plurality of recesses, which can be used to rotate the coil rod.

Each of the upper sections of the lower riser walls includes an inner portion, a middle portion, and an outer portion, with the middle portion being recessed between about 3.5 inches and about 4.5 inches below each of the inner portion and the outer portion, and having a width of between about 3 inches and about 4 inches. The middle portion has a plurality of cylindrical apertures positioned centrally therein, with each cylindrical aperture having a diameter of between about 0.75 inches and about 1.5 inches. Each of the cylindrical apertures has an upper end that terminates at an opening in the middle portion, and extends vertically downward through the lower riser wall, and each cylindrical aperture contains a second coil rod which has an internally threaded portion terminating at the opening in the middle portion. In this embodiment the middle portion of the upper riser walls and the middle portion of the lower riser walls are arranged and configured so that, when the upper riser section is aligned with and placed on the lower riser section, the middle portion of the upper riser walls fits within the middle portion of the lower riser walls and each externally threaded portion of each of the first coil rods aligns with a corresponding internally threaded portion of the second coil rods. This allows the externally threaded portion of the first coil rods to be threaded into the corresponding internally threaded portion of the second coil rods by rotating the coil nut, thereby securing the upper riser section and the lower riser section to each other.

The top surface of the upper riser wall of the present precast utility vault may be adapted to receive and support a removable precast concrete roof slab.

In yet another embodiment, the present disclosure is directed to rectangular upper riser section of a precast concrete utility vault. The upper riser section is formed as a single piece with four upper riser walls and has an open bottom. Each upper riser wall has a top section with a top surface and a bottom section with a bottom surface. The upper riser section may have a weight of between about 30,000 and 45,000 pounds, or of between about 40,000 and about 45,000 pounds; an upper riser wall thickness of between about 8 inches and about 12 inches; a length of between about 10 feet and about 14 feet; a width of between about 10 feet and about 12 feet; and a height of between about 7 feet and about 9 feet.

The bottom section of the upper riser walls includes an inner portion and an outer portion, with the the outer portion extending between about 4 inches and about 8 inches below the inner portion and having a thickness of between about 4.5 inches and 5.5 inches. The inner and outer portions of the upper riser wall are aligned and configured so that, when the upper riser section is aligned with and placed on a lower riser section that has lower riser walls with an upper section having an outer portion and an inner portion, with the inner portion extending between about 4 inches and about 8 inches above the outer portion and having a thickness of between about 4.5 inches and 5.5 inches, the outer portion of the upper riser wall engages the outer portion of the lower riser wall, and the inner portion of the upper riser wall engages the inner portion of the lower riser wall, thereby securing the upper riser section and the lower riser section together.

In the rectangular upper riser section of this embodiment, each of the bottom sections of the upper riser walls includes a first portion and a second portion, with the second portion extending between about 3.5 inches and about 4.5 inches below the first portion and having a thickness of between about 4.5 inches and 5.5 inches. The second portion includes a plurality of rectangular metal plates, which may be steel, that are partially embedded therein coplanar with the upper riser wall and which have a thickness of between about 0.4 inches and 0.6 inches, a length of between about 11 inches and about 13 inches, and a height of between about 11 inches and about 13 inches. Each of the rectangular metal plates has a portion that extends below the bottom surface of the upper riser wall by between about 5 inches and about 7 inches, and that is arranged and configured to correspond to a plurality of rectangular slots in an upper section of a lower riser wall that have a length, width, and depth corresponding to the length, width, and depth of the portion of the rectangular metal plates extending below the bottom surface of the upper riser wall; so that, when the upper riser section is aligned with and placed on the lower riser section, the portion of each metal plate that extends below the bottom surface of the upper riser wall engages with a corresponding rectangular slot to secure the upper riser section and the lower riser section to each other.

Alternatively, in the rectangular upper riser section of this embodiment, each of the bottom sections of the upper riser walls may have an inner portion, a middle portion, and an outer portion. The middle portion extends between about 3.5 inches and about 4.5 inches beyond each of the inner portion and the outer portion, and has a thickness of between about 3 inches and about 4 inches. The upper riser walls have embedded therein a plurality of reinforcing bars that are oriented vertically with respect to the upper riser walls, are positioned midway between the inner portion and the outer portion, and extend into the middle portion. Each reinforcing bar may have a diameter of about 0.5 inches. The middle portion is arranged and configured to correspond to a recessed middle portion of a lower riser wall so that, when the upper riser section is aligned with and placed on the lower riser section, the middle portion of the upper riser walls fits within the middle portion of the lower riser wall to secure the upper riser section and the lower riser section to each other.

In a yet further alternative embodiment of the present rectangular upper riser section, each of the bottom sections of the upper riser walls may have an inner portion, a middle portion, and an outer portion, with the middle portion extending between about 3.5 inches and about 4.5 inches beyond each of the inner portion and the outer portion and having a thickness of between about 3 inches and about 4 inches. The top surface of the top section of the upper riser walls may have a plurality of recesses that are positioned centrally in the upper riser walls and have a width of about 4 inches, a length of about 4 inches, and a depth of about 4 inches. Each of the plurality of recesses has a bottom surface with a cylindrical aperture that is positioned centrally in the bottom surface and has a diameter of between about 0.75 inches and about 1.5 inches. Each of the cylindrical apertures extends vertically downward through the upper riser wall and terminates in an aperture in the bottom surface of the bottom section of the upper riser wall.

Each of these cylindrical apertures contains therein a rigid plastic sleeve having an outer diameter equal to the diameter of the cylindrical apertures, and an inner diameter. Each of the rigid plastic sleeves contains therein a first coil rod extending throughout the cylindrical aperture and having a top and a bottom, the coil rod bottom having an externally threaded portion that extends beyond the middle portion, and the coil rod top having a coil nut that is accessible through the plurality of recesses, whereby the coil rod may be rotated.

In this embodiment each of the upper sections of the lower riser walls comprises an inner portion, a middle portion, and an outer portion, with the middle portion being recessed between about 3.5 inches and about 4.5 inches below each of the inner portion and the outer portion and having a width of between about 3 inches and about 4 inches. The middle portion includes a plurality of cylindrical apertures that are positioned centrally therein, having a diameter of between about 0.75 inches and about 1.5 inches. Each of the cylindrical apertures has an upper end terminating at an opening in the middle portion, and extends vertically downward through the lower riser wall. Each of the cylindrical apertures contains therein a second coil rod, the second coil rod having an internally threaded portion that terminates at the opening in the middle portion. The middle portion of the upper riser walls and the middle portion of the lower riser walls are arranged and configured so that, when the upper riser section is aligned with and placed on the lower riser section, the middle portion of the upper riser walls fits within the middle portion of the lower riser walls, and each externally threaded portion of each of the first coil rods aligns with a corresponding internally threaded portion of the second coil rods, such that the externally threaded portion of the first coil rods may be threaded into the corresponding internally threaded portion of the second coil rods by rotating the coil nut to secure the upper riser section and the lower riser section to each other.

In an alternative embodiment the present disclosure is directed to a rectangular lower riser section of precast concrete that is formed as a single piece, with four lower riser walls having an open top and joined at bottom by a slab section having an upper surface, further with each lower riser wall having an upper section and a top surface. The rectangular lower riser section has a weight of between about 50,000 and 65,000 pounds, or of between about 60,000 and about 65,000 pounds; a lower riser wall thickness of between about 8 inches and 12 inches; a length of between about 10 feet and 14 feet; a width of between about 10 feet and 12 feet; and a height of between about 5 feet and 7 feet. The top surface of the bottom riser walls have a plurality of receiving portions that are aligned and configured to correspond to a plurality of projecting portions in an upper riser section so that, when the upper riser section is aligned with and placed on the lower riser section, each of the plurality of receiving portions and the plurality of projecting portions engages with each other to secure the lower riser section and the upper riser section to each other.

The upper sections of the lower riser walls of the present rectangular lower riser section may include a first portion and a second portion, with the first portion extending between about 3.5 inches and about 4.5 inches above the second portion and having a thickness of between about 4.5 inches and about 5.5 inches. The second portion has a plurality of rectangular slots formed therein that are coplanar with the lower riser walls and which have a thickness of between about 0.4 inches and about 0.6 inches, a length of between about 11 inches and about 13 inches, and a depth of between about 5 inches and about 7 inches.

In a yet further embodiment of the present rectangular lower riser section, each of the upper sections of the lower riser walls has an inner portion, a middle portion, and an outer portion. The middle portion is recessed between about 3.5 inches and about 4.5 inches below each of the inner portion and the outer portion, and has a width of between about 3 inches and about 4 inches. The middle portion includes a plurality of cylindrical apertures that are positioned centrally therein, each having a diameter of between about 0.75 inches and about 1.5 inches. Each of the cylindrical apertures has an upper end that terminates at an opening in the middle portion, and extends vertically downward through the lower riser wall. Each of the cylindrical apertures contains therein a coil rod having an internally threaded portion that terminates at the opening in the middle portion.

### DETAILED DESCRIPTION

A utility vault may be viewed as having three primary sections. The first is the base or slab, a horizontal section that forms the floor of the vault. The second is a number of vertical walls that generally form a rectilinear shape, such a rectangle having four walls. The third is a roof, which rests on the upper surface of the vertical walls. The base, walls, and roof form an enclosure, with any or all also having various apertures to accommodate connections and controls for electrical, gas, steam, water/hydraulic, and fiber optic and telecommunication systems.

In certain installations the concrete to form the vault is poured on-site, and then requires substantial time to properly cure before work can commence on installing the various utility components, conduits, and other features. An alternative is to use precast concrete, where the various sections of a vault are precast in a remote facility and then transported to, and assembled at, the location where the vault will be installed.

Vault sections that are transported to an installation site must be of a weight and size that can be safely and legally accommodated by an appropriate transportation vehicle, meaning, for example, that they cannot exceed the vehicle's load weight specifications; that the combined weight of the vault section or sections being transported on the transportation vehicle plus the weight of the transportation vehicle cannot exceed any load limits on bridges or other road features that will be traveled during transport to the installation site, and that the overall dimensions of the transportation vehicle with the vault section or sections being transported in place cannot violate any laws or regulations governing the any height, width, or length of vehicles on the route traveled to the installation site, including overpass height limitations.

The present precast concrete utility vault is especially suited for housing 2500 kVA, 277/480V transformers.

Where the following description uses terms such as “inner”, “outer”, “upper”, “lower”, and the like, it is to be understood that the locations or orientations of the features so described may be in either order, provided that when the upper riser section is placed on the lower riser section, those features align to secure the two sections together.

For further understanding of the present precast concrete utility vault, the following table provides a description of the labeled elements in the drawings which form part of the present application:

| No. | Element |
|---|---|
| 100 | precast concrete utility vault |
| 1 | rectangular upper riser section |
| 2 | roof slab |
| 3 | sump channel |
| 4 | sump channel drains |
| 5A | height of wall of upper riser section |
| 5B | thickness of wall of upper riser section |
| 6 | rectangular lower riser section |
| 7 | construction joint |
| 8 | slab section |
| 9 | conduits |
| 10 | grating on roof |
| 13 | sump bottom |
| 14 | upper surface of slab section |
| 14 | top surface of top section of upper riser wall |
| 14 | top surface of upper riser wall top section |
| 15 | upper riser wall top section |
| 16 | upper riser wall bottom section |
| 16 | wall of upper riser section |
| 17 | second/inner portion of bottom sections of upper riser walls |
| 17 | inner portion of bottom section of upper riser wall |
| 18 | outer portion of bottom sections of upper riser walls |
| 18A | metal plate |
| 18B | bottom surface of upper riser wall bottom section |
| 19 | inner portion of upper section of lower riser wall |
| 20 | outer portion of upper section of lower riser wall |
| 21 | plurality of slots in second portion |
| 22 | lower riser wall top section |
| 23 | plurality of reinforcing bars in upper riser walls |
| 24 | inner portion of bottom section of upper riser wall |
| 25 | middle portion of bottom section of upper riser wall |
| 26 | outer portion of bottom section of upper riser wall |
| 27 | inner portion of bottom section of lower riser wall |
| 28 | middle portion of bottom section of lower riser wall |
| 29 | outer portion of bottom section of lower riser wall |
| 30 | coil nut |
| 31 | cylindrical aperture |
| 32 | rigid plastic sleeve |
| 33 | first coil rod |
| 33A | coil rod bottom |
| 34 | externally threaded portion of first coil rod |
| 35 | aperture for first coil rod to extend through middle portion of |
| | bottom section of upper riser wall |
| 36 | second coil rod |
| 37 | internally threaded portion of second coil rod |
| D1 | sump channel depth |
| H1 | height of upper riser section |
| H2 | height of lower riser section |
| L1 | length of upper riser section |
| L1 | length of upper riser section |
| L2 | length of lower riser section |
| L2 | length of lower riser section |
| T1 | upper riser wall thickness of upper riser section |
| W1 | width of upper riser section |
| W2 | width of lower riser section |
| W3 | lower riser wall thickness of lower riser section |
| W4 | sump channel width |

In the above table, element 14 is listed three times, with the second and third recitations having effectively the same element description (respectively, “top surface of top section of upper riser wall” and “top surface of upper riser wall top section”); these are more accurate than the first description, “upper surface of slab section”. Element 16 is listed twice; the first description, “upper riser wall bottom section”, is more correct. Element 17 is also listed twice; both element descriptions are effectively the same.

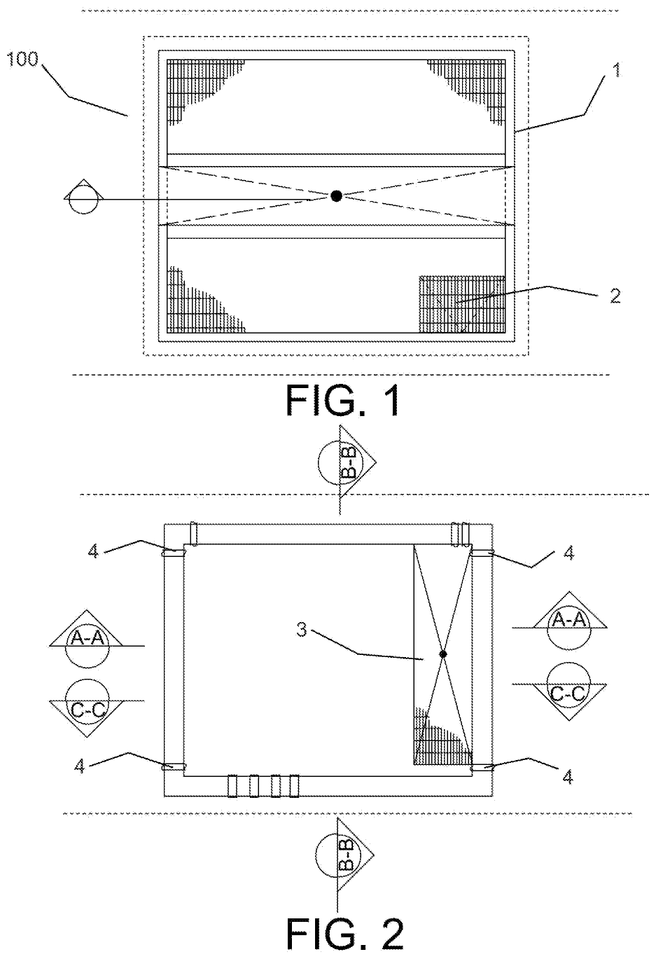

FIG. 1 depicts precast concrete utility vault 100 as seen from above, with rectangular upper riser section 1 and roof slab 2. Roof slab 2 may be solid but at least part may have a grate or similar feature to allow for passage of air.

FIG. 2 shows another top view of the present precast concrete utility vault, without a roof slab in place. Sump channel 3 in the floor of precast concrete utility vault 100 runs along one wall. One or more sump channel drains 4 facilitate the drainage of water from the vault.

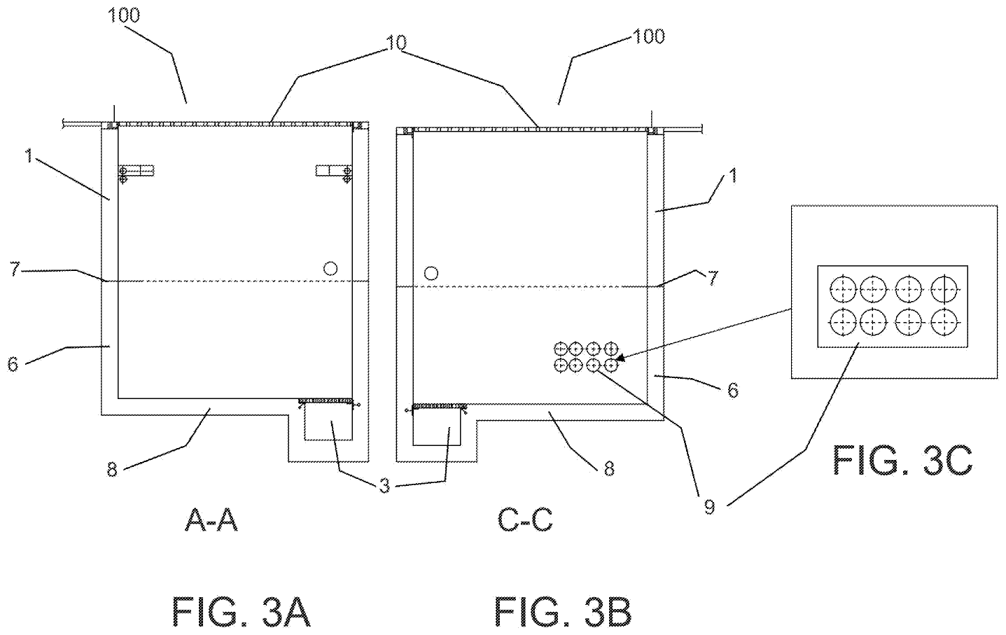

FIGS. 3A and 3B show the present precast concrete utility vault 100 from, respectively, perspectives A-A and C-C of FIG. 2. Both views include rectangular upper riser section 1, shown in a position in which it has been aligned with and placed on rectangular lower riser section 6; the upper and lower riser sections meet at construction joint 7. Grating 10 is present on a roof slab covering the upper riser section. Rectangular lower riser section 6 is formed with slab section 8, which constitutes a floor. Slab section 8 may include sump channel 3, shown as covered by a grate, which runs along most or all of one wall of rectangular lower riser section 6. A wall of rectangular lower riser section 6 may include a plurality of openings for conduits 9, also shown in FIG. 3C.

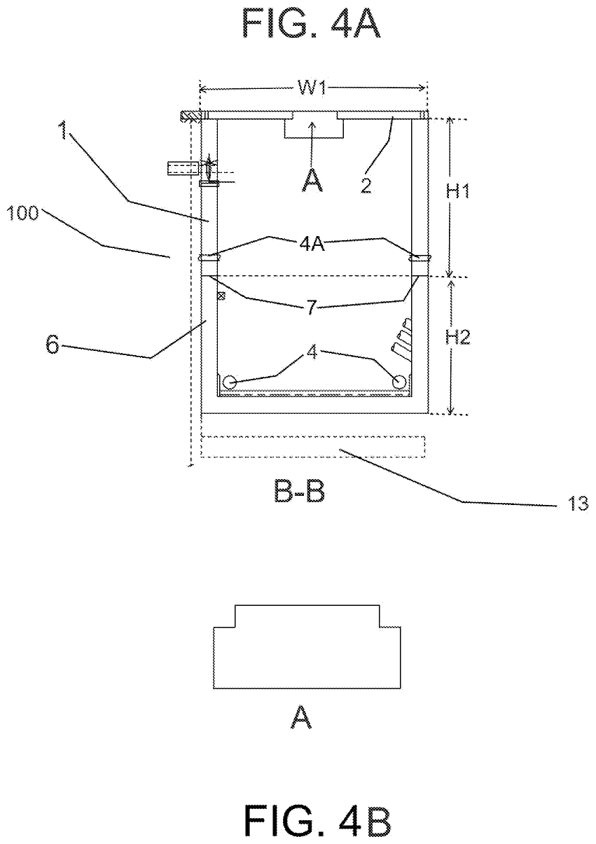

FIG. 4A shows the present precast concrete utility vault 100 from perspective B-B of FIG. 2, covered with roof slab 2. Rectangular upper riser section 1 has height H1, while rectangular lower riser section 6 has height H2; rectangular upper riser section 1 and rectangular lower riser section 6 each have width Wi. Rectangular upper riser section 1 and lower riser section 6 are joined at construction joint 7. Rectangular upper riser section 1 includes sewer drains 4A, while lower riser section 6 includes sump channel drains 4. Also shown is sump bottom 13 of sump channel 3, which is not visible on this view. FIG. 4B shows detail A of FIG. 4A.

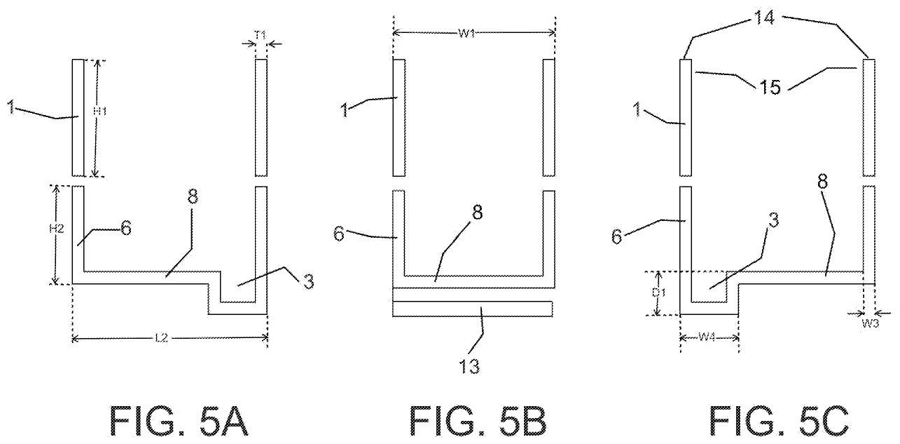

FIGS. 5A-5C are views of the present vault from three sides. If, for purposes of reference only, the side where sump channel 3 is located is designated as the rear, with the facing side being the front and the two other sides being left and right, FIG. 5A is a right side view showing rectangular upper riser section 1, having height H1 and wall thickness T1, and rectangular lower riser section 6 with slab section 8. Rectangular lower riser section 6 has height H2, measured as shown from the bottom of slab section 8 to the top of rectangular lower riser section 6, and length L2. FIG. 5B is a front view showing rectangular upper riser section 1, having height H1 and wall thickness T1, and rectangular lower riser section 6 with slab section 8 and showing sump channel bottom 13. FIG. 5C is a right side view showing rectangular upper riser section 1, including top surface 14 of top section of upper riser wall top section 15, and rectangular lower riser section 6 with slab section 8. Rectangular lower riser section 6 has wall thickness W3. FIG. 5C includes a side view of sump channel 3 having a depth D1 below the surface of slab section 8, and a width W4.

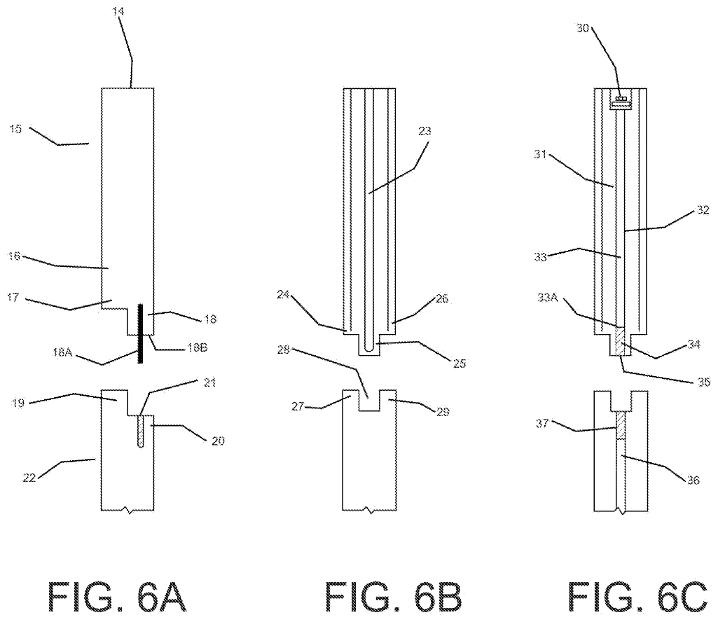

FIGS. 6A-6C show alternative construction joints for joining rectangular upper riser section 1 and rectangular lower riser section 6 when rectangular upper riser section 1 is aligned with and placed on rectangular lower riser section 6. FIG. 6A shows upper riser wall top section 15 having top surface 14. The lower or bottom section of the upper riser wall includes inner portion 17 and outer portion 18, which as seen extends below inner portion 17 by between about 4 inches and about 8 inches. Inner portion 17 and outer portion 18 may each have a thickness of between about 4.5 inches and 5.5 inches. Outer portion 18 includes a plurality of metal plates 18A that are each partially embedded therein, oriented coplanar with the upper riser wall, and having a thickness of between about 0.4 inches and 0.6 inches, a length of between about 11 inches and about 13 inches, and a height of between about 11 inches and about 13 inches. A portion of each metal plate 18A extends below bottom surface 18B of the bottom section of the upper riser wall by between about 5 inches and about 7 inches.

Also shown in FIG. 6A is lower riser wall upper/top section 22, with inner portion 19 and outer portion 20. Outer portion 20 includes a plurality of slots 21. As may be seen, inner portion 17 and outer portion 18 of the lower or bottom section of the upper riser wall are complementary to, or mirror images of, inner portion 19 and outer portion 20 of lower riser wall upper section 22, and each of slots 21 in outer portion 20 of lower riser wall upper section 22 are complementary to the portion of each metal plate 18A that extends below bottom surface 18B of the bottom section of the upper riser wall. It will be appreciated that when rectangular upper riser section 1 is aligned with and placed on rectangular lower riser section 6, their respective inner and outer sections will mesh or match, and the extended portions of metal plates 18A will be inserted into slots 21, securing the upper riser section and bottom riser section together.

FIG. 6B similarly shows a portion of a bottom section of the upper riser wall and an upper portion of the lower riser wall. The upper riser wall contains a plurality of reinforcing bars, or “rebar”, 23. The bottom section of the upper riser wall includes inner portion 24, middle portion 25, and outer portion 26. The upper portion of the lower riser wall includes corresponding inner portion 27, middle portion 28, and outer portion 29. It will be appreciated that, as the upper riser section is placed on the lower riser section, middle portion 25 of the upper riser section will enter middle portion 28 of the lower riser section, and the facing surfaces of the respective inner and outer portions will meet, securing the upper riser section and bottom riser section together. In this embodiment the middle of the upper riser wall may include a rebar that extends into middle portion 25, providing additional strength and stability when the upper riser section and bottom riser section are joined.

FIG. 6C show another construction joint, similar to that shown in FIG. 6B. Here, the upper riser wall includes a central cylindrical aperture 31, which contains rigid plastic sleeve 32; any suitable plastic may be used, including polyvinyl chloride (PVC). Cylindrical aperture 31 extends from an aperture located in a recess in the top section of the upper riser wall, to another aperture 35 in the bottom of the middle portion of the bottom section of the upper riser wall. First coil rod 33 is located within rigid plastic sleeve 32, and includes coil nut 30 located at its top within the recess as shown, while coil rod bottom 33A of first coil rod 33 includes externally threaded portion 34, which can be extended through aperture 35. The middle portion of the upper portion of the lower riser wall includes second coil rod 36, having internally threaded portion 37 at its upper end. It will again be appreciated that, as the upper riser section is placed on the lower riser section, the middle portion of the upper riser section will enter the middle portion of the lower riser section, and the facing surfaces of the respective inner and outer portions will meet. Coil nut 30 may then be manipulated to extend externally threaded portion 34 of coil rod 33 through aperture 35 and into internally threaded portion 37 of second coil rod 36, and rotated to thread externally threaded portion 34 into internally threaded portion 37, thereby further securing the upper riser section and bottom riser section together.

For each of the construction joints described herein, a bonding or similar compound, such as uniweld bonding compound, may be applied to the facing surfaces of the upper riser section and/or of the lower riser section prior to placing the upper riser section on the lower riser section.

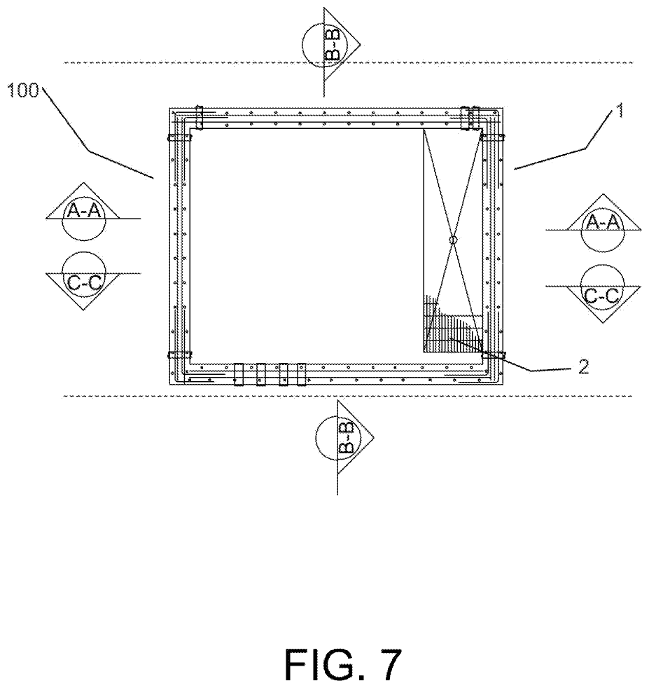

FIG. 7 shows the present precast concrete utility vault 100 in a view similar to that of FIG. 1, including roof slab 2, with additional detail in the form of small circles showing possible placement of rebar within the walls of rectangular upper riser section 1.

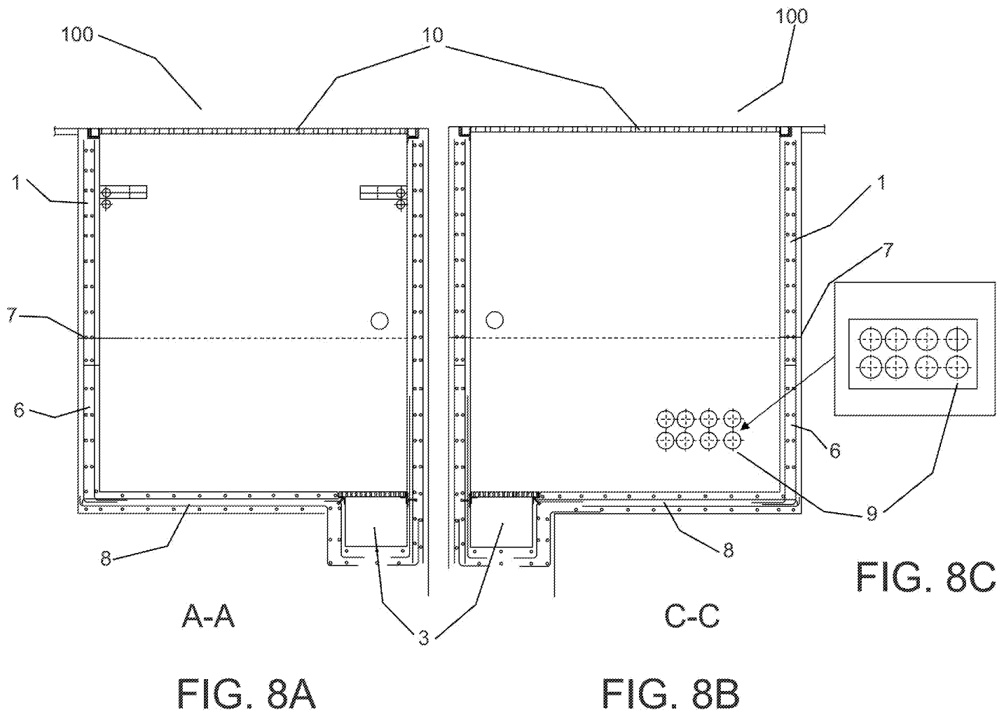

FIGS. 8A-8C show the present precast concrete utility vault 100 in a view similar to that of FIGS. 3A-3C. In particular, FIGS. 8A and 8B show precast concrete utility vault 100 from, respectively, perspectives A-A and C-C of FIG. 7. Both views include rectangular upper riser section 1, shown in a position in which it has been aligned with and placed on rectangular lower riser section 6; the upper and lower riser sections meet at construction joint 7. Grating 10 is present on a roof slab covering the upper riser section. Rectangular lower riser section 6 is formed with slab section 8, which constitutes a floor. Slab section 8 may include sump channel 3, shown as covered by a grate, which runs along most or all of one wall of rectangular lower riser section 6. A wall of rectangular lower riser section 6 may include a plurality of openings for conduits 9, also shown in FIG. 8C.

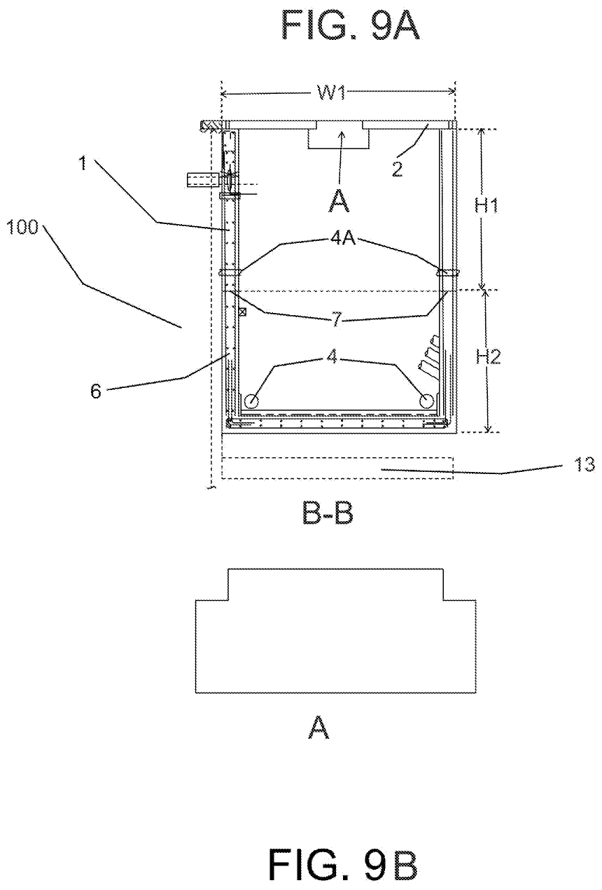

FIGS. 9A-9B show the present precast concrete utility vault 100 in a view similar to that of FIGS. 4A-4B. In particular, FIG. 9A shows precast concrete utility vault 100 from perspective B-B of FIG. 7, covered with roof slab 2. Rectangular upper riser section 1 has height H1, while rectangular lower riser section 6 has height H2; rectangular upper riser section 1 and rectangular lower riser section 6 each have width Wi. Rectangular upper riser section 1 and lower riser section 6 are joined at construction joint 7. Rectangular upper riser section 1 includes sewer drains 4A, while lower riser section 6 includes sump channel drains 4. Also shown is sump bottom 13 of sump channel 3, which is not visible on this view. FIG. 9B shows detail A of FIG. 9A.

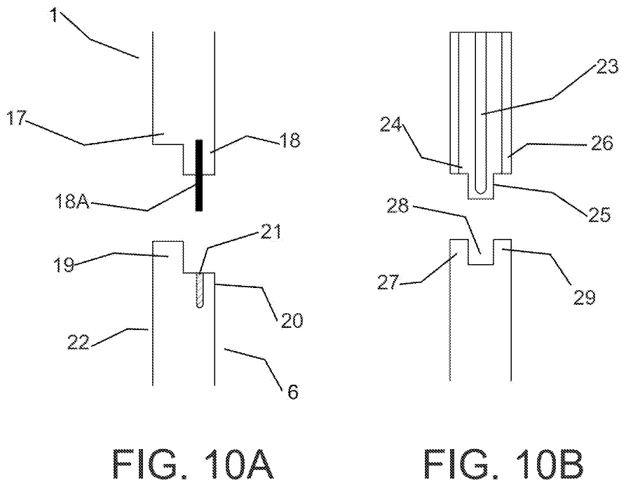

FIGS. 10A and 10B are similar to FIGS. 10A and 10B. In particular, FIG. 10A shows inner portion 17 and outer portion 18 of the lower or bottom section of the upper riser wall, with outer portion 18 having a plurality of metal plates 18A that are each partially embedded therein, oriented coplanar with the upper riser wall, and having a thickness of between about 0.4 inches and 0.6 inches, a length of between about 11 inches and about 13 inches, and a height of between about 11 inches and about 13 inches. A portion of each metal plate 18A extends below the bottom surface of outer portion 18 by between about 5 inches and about 7 inches.

Also shown in FIG. 10A is lower riser wall upper/top section 22, with inner portion 19 and outer portion 20. Outer portion 20 includes a plurality of slots 21. As may be seen, inner portion 17 and outer portion 18 of the lower or bottom section of the upper riser wall are complementary to, or mirror images of, inner portion 19 and outer portion 20 of lower riser wall upper section 22, and each of slots 21 in outer portion 20 of lower riser wall upper section 22 are complementary to the portion of each metal plate 18A that extends below the bottom surface of the bottom section of the upper riser wall. It will be appreciated that when rectangular upper riser section 1 is aligned with and placed on rectangular lower riser section 6, their respective inner and outer sections will mesh or match, and the extended portions of metal plates 18A will be inserted into slots 21, securing the upper riser section and bottom riser section together.

FIG. 10B similarly shows a portion of a bottom section of the upper riser wall and an upper portion of the lower riser wall. The upper riser wall contains a plurality of reinforcing bars 23. The bottom section of the upper riser wall includes inner portion 24, middle portion 25, and outer portion 26. The upper portion of the lower riser wall includes corresponding inner portion 27, middle portion 28, and outer portion 29. It will be appreciated that, as the upper riser section is placed on the lower riser section, middle portion 25 of the upper riser section will enter middle portion 28 of the lower riser section, and the facing surfaces of the respective inner and outer portions will meet, securing the upper riser section and bottom riser section together. In this embodiment the middle of the upper riser wall may include a plurality of rebars 23 that extends into middle portion 25, providing additional strength and stability when the upper riser section and bottom riser section are joined.

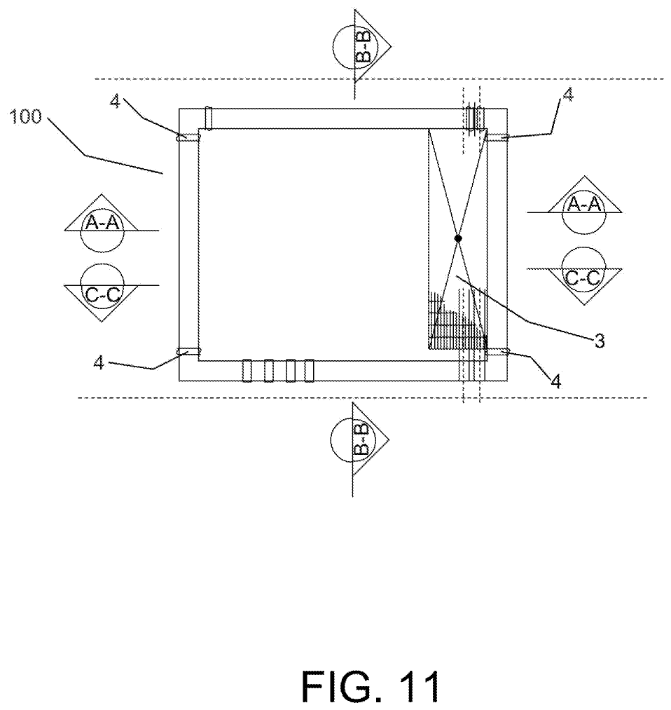

FIG. 11 is similar to FIG. 2, showing a top view of precast concrete utility vault 100, without a roof slab in place. Sump channel 3 in the floor of precast concrete utility vault 100 runs along one wall. One or more sump channel drains 4 facilitate the drainage of water from the vault.

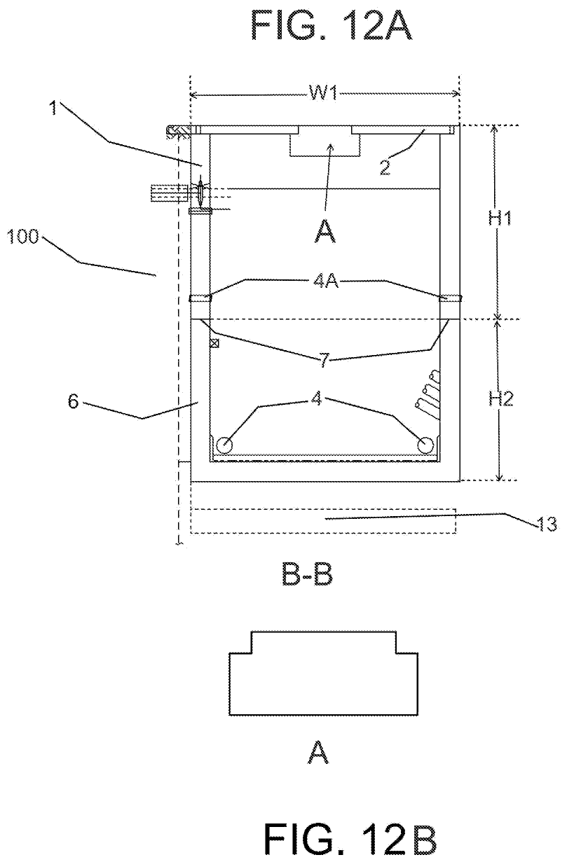

FIGS. 12A and 12B are similar to FIGS. 4A-4B and 9A-9B. In particular, FIG. 12A shows precast concrete utility vault 100 from perspective B-B of FIG. 11, covered with roof slab 2. Rectangular upper riser section 1 has height H1, while rectangular lower riser section 6 has height H2; rectangular upper riser section 1 and rectangular lower riser section 6 each have width Wi. Rectangular upper riser section 1 and lower riser section 6 are joined at construction joint 7. Rectangular upper riser section 1 includes sewer drains 4A, while lower riser section 6 includes sump channel drains 4. Also shown is sump bottom 13 of sump channel 3, which is not visible on this view. FIG. 12B shows detail A of FIG. 12A.

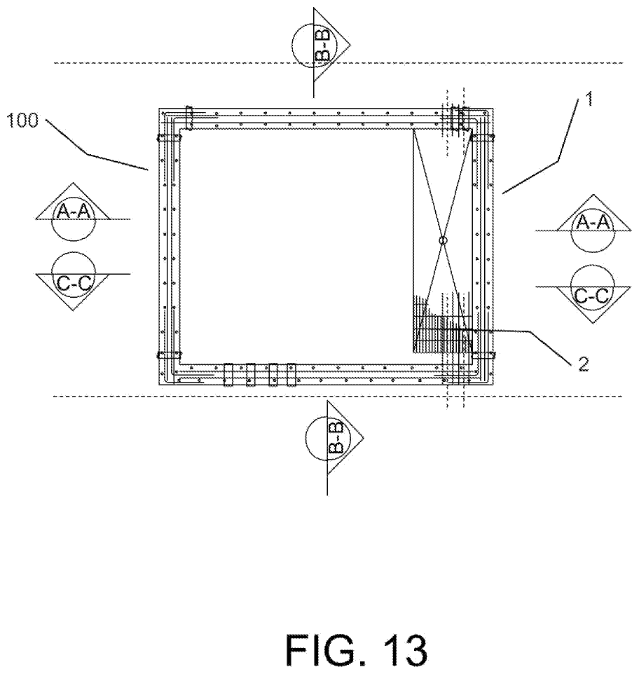

FIG. 13 presents a view of precast concrete utility vault 100 similar to that of FIG. 7, including roof slab 2, with detail in the form of small circles showing possible placement of rebar within the walls of rectangular upper riser section 1.

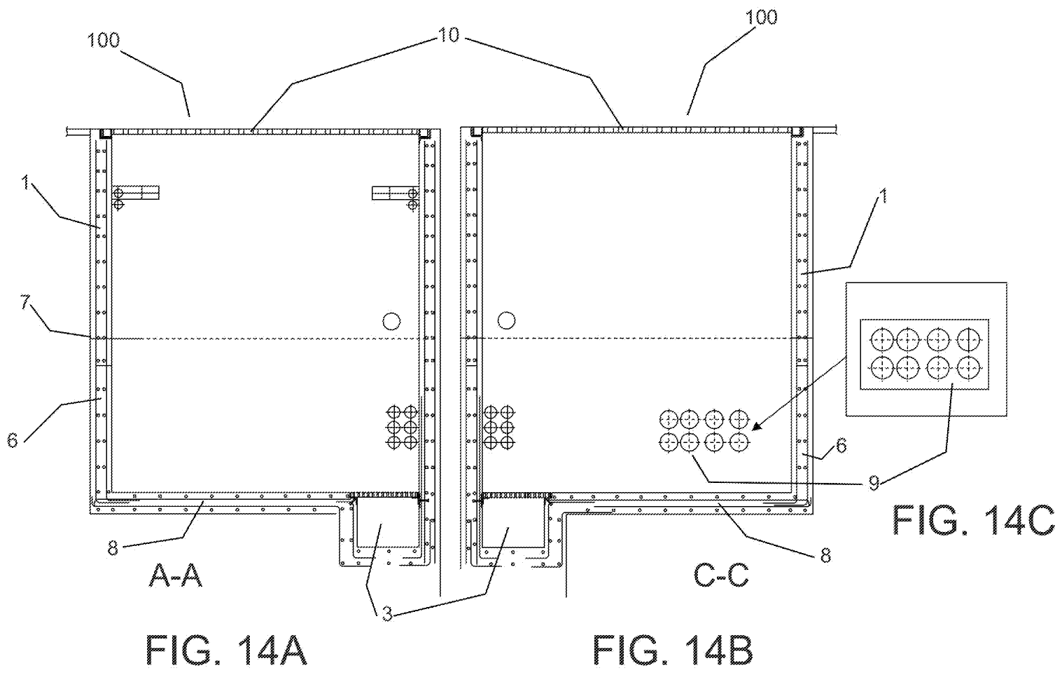

FIGS. 14A-14C show the present precast concrete utility vault 100 in a view similar to that of FIGS. 3A-3C and 8A-8C. In particular, FIGS. 14A and 14B show precast concrete utility vault 100 from, respectively, perspectives A-A and C-C of FIG. 13. Both views include rectangular upper riser section 1, shown in a position in which it has been aligned with and placed on rectangular lower riser section 6; the upper and lower riser sections meet at construction joint 7. Grating 10 is present on a roof slab covering the upper riser section. Rectangular lower riser section 6 is formed with slab section 8, which constitutes a floor. Slab section 8 may include sump channel 3, shown as covered by a grate, which runs along most or all of one wall of rectangular lower riser section 6. A wall of rectangular lower riser section 6 may include a plurality of openings for conduits 9, also shown in FIG. 8C.

The present precast concrete utility vault may be formed of 5,000 psi concrete. The upper riser section may have a weight of between about 30,000 and about 45,000 pounds, or of between about 40,000 and 45,000 pounds, while the lower riser section may have a weight of between about 50,000 and about 65,000 pounds, or of between about 60,000 and about 56,000 pounds. The walls of the upper and lower riser sections may have a thickness of between about 8 inches and about 12 inches, including a thickness of about 10 inches. The upper and lower riser sections may each have a length of between about 10 feet and 14 feet, including about 12 feet or about 13 feet 8 inches, and a width of between about 10 feet and about 12 feet, including about 9 feet and 8 inches or about 11 feet 4 inches. The upper riser section may have a height of between about 7 feet and about 9 feet, including about 8 feet, while the lower riser section may have a height of between about 5 feet and about 7 feet, including about 6 feet.

The bottom section of said upper riser walls, and the upper sections of the lower riser walls, may each be divided into inner portion and an outer portion of about equal thickness, therefore, of between about 4.5 inches and about 5.5 inches. The outer portion of the bottom section of the upper riser walls may extend beyond the inner portion of the bottom section of the upper riser walls by between about 4 inches and about 8 inches. Similarly, the inner portion of the bottom section of the lower riser walls may extend beyond the outer portion of the bottom section of the lower riser walls by between about 4 inches and about 8 inches. It will be understood that the outer portion of the bottom section of the upper riser walls, and the inner portion of the bottom section of the lower riser walls, will extend beyond their respective inner portion and outer portion by the same amount so that they will fully engage when the upper riser section is placed on the lower riser section.

Alternatively, the bottom section of said upper riser walls, and the upper sections of the lower riser walls, may each be divided into inner portion, a middle section, and an outer portion of about equal thickness, therefore, of between about 3 inches and about 3.5 inches. The middle portion of the bottom section of the upper riser walls may extend beyond the inner portion and the outer portion of the bottom section of the upper riser walls by between about 4 inches and about 8 inches. Similarly, the inner portion and the outer portion of the upper section of the lower riser walls may extend beyond the middle portion of the upper section of the lower riser walls by between about 4 inches and about 8 inches. It will be understood that (a) the middle portion of the bottom section of the upper riser walls will extend beyond the inner portion and outer portion of the bottom section of the upper riser walls, and (2) the inner portion and the outer portion of the upper section of the lower riser walls will extend beyond the middle portion of the upper section of the lower riser walls, by the same amount so that they will fully engage when the upper riser section is placed on the lower riser section.

The sump channel of the present precast concrete utility vault may have a depth of between about 1.5 feet and about 2.5 feet below the upper surface of the floor/slab section, a width of between about 2 feet and about 3 feet, and a length of between about 8 feet 8 inches and 9 feet 8 inches. The sump channel may be adjacent one wall of the precast concrete utility vault and extend between about one-half the length of that wall and about the entire length of that wall, or any amount in-between, including but not limited to 95%, 90%, 85%, 80%, and 75% of that length.

The metal plates partially embedded in the second portion of the bottom section of the upper riser walls may have a length of between about 11 inches and about 13 inches, including about 12 inches; a width of between about 11 inches and about 13 inches, including about 12 inches; and a thickness of between about 0.4 inches and about 0.6 inches, including about 0.5 inches. The metal plates may extend below the bottom surface of the upper riser wall by between about 5 inches and about 7 inches, including by about 6 inches. The metal plates may be steel. The reinforcing bars used in the present precast concrete utility vault may have a diameter of about 0.5 inches.

Where the present precast concrete utility vault includes a cylindrical aperture in the middle portion of the upper riser walls and lower riser walls, the cylindrical aperture may have a diameter of between about 0.75 inches and about 1.5 inches, including about 1.0 inches. It will be appreciated that when the precast concrete utility vault includes a cylindrical aperture, rigid plastic sleeve, and coil, their diameters will be selected such that the rigid plastic sleeve fits inside the cylindrical aperture and the coil rod fits inside, and can be rotated within, the rigid plastic sleeve.

The present precast concrete utility vault may be manufactured in a controlled environment such as a concrete plant or factory, such that the ambient conditions can be controlled to minimize or eliminate the presence of air pockets, excess moisture, particulates, and other contaminants that could weaken the resulting concrete. Temperature, humidity, and cure time can also be controlled to produce the desired product. The resulting upper and lower riser sections are then transported to the site where the vault will be installed; the lower riser section is put in place; the upper riser section is placed on top of the lower riser section; and the upper and lower riser sections are secured together as described herein.

While the present precast concrete utility vault has been described with reference to particular embodiments, including lengths, widths, heights, weights, shapes, and materials, it will be understood by those skilled in the art that various changes may be made and equivalents may be substituted therefor thereof without departing from the intended scope. In addition, many modifications may be made to adapt a particular situation or material to these teachings without departing from the intended scope.

Therefore, it is intended that the scope not be limited to the particular embodiments disclosed herein, but rather will include all embodiments falling within the scope and spirit thereof.

What I/We claim is:

1. A precast concrete utility vault comprising:
a) a rectangular upper riser section of 5,000 psi precast concrete formed as a single piece with four upper riser walls and having an open bottom, each upper riser wall having a top section with a top surface and a bottom section with a bottom surface, said upper riser section further comprising:
i) a weight of between about 30,000 and 45,000 pounds,
ii) an upper riser wall thickness of between about 8 inches and 12 inches,
iii) a length of between about 10 feet and 14 feet,
iv) a width of between about 10 feet and 12 feet, and
v) a height of between about 7 feet and 9 feet;
b) a rectangular lower riser section of precast concrete formed as a single piece with four lower riser walls having an open top and joined at bottom by a slab section having an upper surface, each lower riser wall having an upper section and a top surface, said lower riser section further comprising:
i) a weight of between about 50,000 and 65,000 pounds,
ii) a lower riser wall thickness of between about 8 inches and 12 inches,
iii) a length of between about 10 feet and 14 feet,
iv) a width of between about 10 feet and 12 feet, and
v) a height of between about 5 feet and 7 feet;
further wherein said bottom surface of said upper riser walls comprises a plurality of projecting portions and said top surface of said bottom riser walls comprises a corresponding plurality of receiving portions, said projecting portions and said receiving portions being aligned and configured so that, when said upper riser section is aligned with and placed on said lower riser section, each of said plurality of projecting portions and said plurality of receiving portions engages with each other to secure said upper riser section and said lower riser section to each other.

2. The precast utility vault of claim 1 wherein said rectangular upper riser section has a weight of between about 40,000 and about 45,000 pounds and said rectangular lower riser section has a weight of between about 60,000 and about 65,000 pounds.

3. The precast utility vault of claim 1 wherein said slab section comprises a sump channel along the length of one of said lower riser walls.

4. The precast utility vault of claim 3 wherein said sump channel has a depth of between about 1.5 feet and about 2.5 feet below said upper surface and a width of between about 2 feet and about 3 feet.

5. The precast utility vault of claim 1 wherein:
a) each of said bottom sections of said upper riser walls comprises a first portion and a second portion, said second portion extending between about 3.5 inches and about 4.5 inches below said first portion and having a thickness of between about 4.5 inches and 5.5 inches;
b) said second portion further comprising a plurality of metal plates partially embedded therein coplanar with said upper riser wall and having a thickness of between about 0.4 inches and 0.6 inches, a length of between about 11 inches and about 13 inches, and a height of between about 11 inches and about 13 inches;
c) each of said metal plates having a portion extending below said bottom surface of said upper riser wall by between about 5 inches and about 7 inches;
d) further wherein each of said upper sections of said lower riser walls comprises a first portion and a second portion, said first portion extending between about 3.5 inches and about 4.5 inches above said second portion and having a thickness of between about 4.5 inches and about 5.5 inches;
e) said second portion further comprising a plurality of slots formed therein and having a length, width, and depth corresponding to the length, width, and depth of the portion of said metal plates extending below said bottom surface of said upper riser wall;
f) said metal plates and said slots arranged and configured so that, when said upper riser section is aligned with and placed on said lower riser section, each of said plurality of metal plates engages with each of said plurality of slots to secure said upper riser section and said lower riser section to each other.

6. The precast utility vault of claim 5 wherein said metal plate is a steel plate.

7. The precast utility vault of claim 1 wherein:
a) each of said bottom sections of said upper riser walls comprises an inner portion, a middle portion, and an outer portion, said middle portion extending between about 3.5 inches and about 4.5 inches beyond each of said inner portion and said outer portion and having a thickness of between about 3 inches and about 4 inches;
b) said upper riser walls having embedded therein a plurality of reinforcing bars that
i) are oriented vertically with respect to said upper riser walls,
ii) are positioned midway between said inner portion and said outer portion, and
iii) extend into said middle portion,
each of said plurality of reinforcing bars having a diameter of about 0.5 inches;
c) further where each of said upper sections of said lower riser walls comprises an inner portion, a middle portion, and an outer portion, said middle portion being recessed between about 3.5 inches and about 4.5 inches below each of said inner portion and said outer portion and having a width of between about 3 inches and about 4 inches;
d) said middle portion of said upper riser walls and said middle portion of said lower riser walls arranged and configured so that, when said upper riser section is aligned with and placed on said lower riser section, said middle portion of said upper riser walls fits within said middle portion of said lower riser walls to secure said upper riser section and said lower riser section to each other.

8. The precast utility vault of claim 1 wherein:
a) each of said bottom sections of said upper riser walls comprises an inner portion, a middle portion, and an outer portion, said middle portion extending between about 3.5 inches and about 4.5 inches beyond each of said inner portion and said outer portion and having a thickness of between about 3 inches and about 4 inches;
b) said top surface of said top section of said upper riser walls comprising a plurality of recesses positioned centrally in said upper riser walls and having a width of about 4 inches, a length of about 4 inches, and a depth of about 4 inches,
c) each of said plurality of recesses having a bottom surface comprising a cylindrical aperture positioned centrally in said bottom surface and having a diameter of between about 0.75 inches and about 1.5 inches,
d) each of said cylindrical apertures extending vertically downward through said upper riser wall and terminating in an aperture in said bottom surface of said bottom section of said upper riser wall,
e) each of said cylindrical apertures containing therein a rigid plastic sleeve having an outer diameter equal to the diameter of said cylindrical apertures, and an inner diameter,
f) each of said rigid plastic sleeves containing therein a first coil rod extending throughout said cylindrical aperture and having a top and a bottom, said coil rod bottom comprising an externally threaded portion that extends beyond said middle portion, and said top comprising a coil nut accessible through said plurality of recesses, whereby said coil rod may be rotated,
g) further where each of said upper sections of said lower riser walls comprises an inner portion, a middle portion, and an outer portion, said middle portion being recessed between about 3.5 inches and about 4.5 inches below each of said inner portion and said outer portion and having a width of between about 3 inches and about 4 inches,
h) said middle portion comprising a plurality of cylindrical apertures positioned centrally therein and having a diameter of between about 0.75 inches and about 1.5 inches,
i) each of said cylindrical apertures having an upper end terminating at an opening in said middle portion and extending vertically downward through said lower riser wall,
j) each of said cylindrical apertures containing therein a second coil rod, said second coil rod comprising an internally threaded portion terminating at said opening in said middle portion,
k) said middle portion of said upper riser walls and said middle portion of said lower riser walls arranged and configured so that, when said upper riser section is aligned with and placed on said lower riser section, said middle portion of said upper riser walls fits within said middle portion of said lower riser walls and each externally threaded portion of each of said first coil rods aligns with a corresponding internally threaded portion of said second coil rods,
whereby said externally threaded portion of said first coil rods may be threaded into said corresponding internally threaded portion of said second coil rods by rotating said coil nut.

9. The precast utility vault of claim 1 wherein said top surface of said upper riser wall is adapted to receive and support a removable precast concrete roof slab.

10. A rectangular upper riser section of a precast concrete utility vault, said upper riser section formed as a single piece with four upper riser walls and having an open bottom, each upper riser wall having a top section having a top surface and a bottom section having a bottom surface, said upper riser section further comprising:
a) a weight of between about 30,000 and 45,000 pounds,
b) an upper riser wall thickness of between about 8 inches and 12 inches,
c) a length of between about 10 feet and 14 feet,
d) a width of between about 10 feet and 12 feet, and
e) a height of between about 7 feet and 9 feet,
further wherein said bottom surface of said upper riser walls comprises a plurality of projecting portions aligned and configured to correspond to a plurality of receiving portions in a lower riser section so that, when said upper riser section is aligned with and placed on the lower riser section, each of said plurality of projecting portions engages with each of the plurality of receiving portions to secure said upper riser section and the lower riser section to each other.

11. The rectangular upper riser section of claim 10, having a weight of between about 40,000 and 45,000 pounds.

12. The rectangular upper riser section of claim 10 wherein:
a) each of said bottom sections of said upper riser walls comprises a first portion and a second portion, said second portion extending between about 3.5 inches and about 4.5 inches below said first portion and having a thickness of between about 4.5 inches and 5.5 inches;
b) said second portion further comprising a plurality of rectangular metal plates partially embedded therein coplanar with said upper riser wall and having a thickness of between about 0.4 inches and 0.6 inches, a length of between about 11 inches and about 13 inches, and a height of between about 11 inches and about 13 inches;
c) each of said rectangular metal plates having a portion that extends below said bottom surface of said upper riser wall by between about 5 inches and about 7 inches and that is arranged and configured to correspond to a plurality of rectangular slots in an upper section of a lower riser wall that have a length, width, and depth corresponding to the length, width, and depth of the portion of said rectangular metal plates extending below said bottom surface of said upper riser wall;
so that, when said upper riser section is aligned with and placed on the lower riser section, each of said plurality of rectangular metal plates engages with each of the plurality of rectangular slots to secure said upper riser section and the lower riser section to each other.

13. The rectangular upper riser section of claim 12 wherein said metal plate is a steel plate.

14. The rectangular upper riser section of claim 10 wherein:
a) each of said bottom sections of said upper riser walls comprises an inner portion, a middle portion, and an outer portion, said middle portion extending between about 3.5 inches and about 4.5 inches beyond each of said inner portion and said outer portion and having a thickness of between about 3 inches and about 4 inches;
b) said upper riser walls having embedded therein a plurality of reinforcing bars that
i) are oriented vertically with respect to said upper riser walls,
ii) are positioned midway between said inner portion and said outer portion, and
iii) extend into said middle portion,
each of said plurality of reinforcing bars having a diameter of about 0.5 inches;
c) said middle portion arranged and configured to correspond to a recessed middle portion of a lower riser wall so that, when said upper riser section is aligned with and placed on the lower riser section, said middle portion of said upper riser walls fits within the middle portion of the lower riser wall to secure said upper riser section and the lower riser section to each other.

15. The rectangular upper riser section of claim 10 wherein:
a) each of said bottom sections of said upper riser walls comprises an inner portion, a middle portion, and an outer portion, said middle portion extending between about 3.5 inches and about 4.5 inches beyond each of said inner portion and said outer portion and having a thickness of between about 3 inches and about 4 inches;
b) said top surface of said top section of said upper riser walls comprising a plurality of recesses positioned centrally in said upper riser walls and having a width of about 4 inches, a length of about 4 inches, and a depth of about 4 inches,
c) each of said plurality of recesses having a bottom surface comprising a cylindrical aperture positioned centrally in said bottom surface and having a diameter of between about 0.75 inches and about 1.5 inches,
d) each of said cylindrical apertures extending vertically downward through said upper riser wall and terminating in an aperture in said bottom surface of said bottom section of said upper riser wall,
e) each of said cylindrical apertures containing therein a rigid plastic sleeve having an outer diameter equal to the diameter of said cylindrical apertures, and an inner diameter,
f) each of said rigid plastic sleeves containing therein a first coil rod extending throughout said cylindrical aperture and having a top and a bottom, said coil rod bottom comprising an externally threaded portion that extends beyond said middle portion, and said top comprising a coil nut accessible through said plurality of recesses, whereby said coil rod may be rotated,
g) further where each of said upper sections of said lower riser walls comprises an inner portion, a middle portion, and an outer portion, said middle portion being recessed between about 3.5 inches and about 4.5 inches below each of said inner portion and said outer portion and having a width of between about 3 inches and about 4 inches,
h) said middle portion comprising a plurality of cylindrical apertures positioned centrally therein and having a diameter of between about 0.75 inches and about 1.5 inches,
i) each of said cylindrical apertures having an upper end terminating at an opening in said middle portion and extending vertically downward through said lower riser wall,
j) each of said cylindrical apertures containing therein a second coil rod, said second coil rod comprising an internally threaded portion terminating at said opening in said middle portion,
k) said middle portion of said upper riser walls and said middle portion of said lower riser walls arranged and configured so that, when said upper riser section is aligned with and placed on said lower riser section, said middle portion of said upper riser walls fits within said middle portion of said lower riser walls and each externally threaded portion of each of said first coil rods aligns with a corresponding internally threaded portion of said second coil rods,
whereby said externally threaded portion of said first coil rods may be threaded into said corresponding internally threaded portion of said second coil rods by rotating said coil nut.

16. The rectangular upper riser section of claim 10 wherein said top surface of said upper riser wall is adapted to receive and support a removable precast concrete roof slab.

17. A rectangular lower riser section of precast concrete formed as a single piece with four lower riser walls having an open top and joined at bottom by a slab section having an upper surface, each lower riser wall having an upper section and a top surface, said rectangular lower riser section further comprising:
a) a weight of between about 50,000 and 65,000 pounds,
b) a lower riser wall thickness of between about 8 inches and 12 inches,
c) a length of between about 10 feet and 14 feet,
d) a width of between about 10 feet and 12 feet, and
e) a height of between about 5 feet and 7 feet,
wherein said top surface of said bottom riser walls comprises a plurality of receiving portions aligned and configured to correspond to a plurality of projecting portions in an upper riser section so that, when the upper riser section is aligned with and placed on said lower riser section, each of said plurality of receiving portions and the plurality of projecting portions engages with each other to secure said lower riser section and the upper riser section to each other.

18. The rectangular lower riser section of claim 17, having a weight of between about 60,000 and about 65,000 pounds.

19. The rectangular lower riser section of claim 17 wherein:
f) each of said upper sections of said lower riser walls comprises a first portion and a second portion, said first portion extending between about 3.5 inches and about 4.5 inches above said second portion and having a thickness of between about 4.5 inches and about 5.5 inches;
g) said second portion further comprising a plurality of rectangular slots formed therein coplanar with said lower riser walls and having a thickness of between about 0.4 inches and about 0.6 inches, a length of between about 11 inches and about 13 inches, and a depth of between about 5 inches and about 7 inches.

20. The rectangular lower riser section of claim 17 wherein each of said upper sections of said lower riser walls comprises an inner portion, a middle portion, and an outer portion, said middle portion being recessed between about 3.5 inches and about 4.5 inches below each of said inner portion and said outer portion and having a width of between about 3 inches and about 4 inches; said middle portion comprising a plurality of cylindrical apertures positioned centrally therein and having a diameter of between about 0.75 inches and about 1.5 inches,
each of said cylindrical apertures having an upper end terminating at an opening in said middle portion and extending vertically downward through said lower riser wall;
each of said cylindrical apertures containing therein a coil rod, said coil rod comprising an internally threaded portion terminating at said opening in said middle portion.
